(19) United States
(12) Patent Application Publication
(10) Pub. No.: US 2004/0219422 A1
(43) Pub. Date: Nov. 4, 2004

(54) Modular battery pack

(76) Inventors: Eric W. Hauck, San Diego, CA (US); Rich Scharf, Escondido, CA (US); Tim Morrison, Oceanside, CA (US); Dave Schmeling, San Diego, CA (US)

Correspondence Address: John L. Rogitz, Esq., ROGITZ & ASSOCIATES, Suite 3120, 750 "B" Street, San Diego, CA, 92101, US

(21) Appl. No.: 10/428,588

(22) Filed: May 1, 2003

(51) Int. Cl. H01M 2/10; H01M 2/20

(52) U.S. Cl. 429/96; 429/159; 429/99

(57) ABSTRACT

A modular thin-line battery pack for, e.g., motorized window coverings can hold one or two columns of type AA batteries end-to-end. The battery pack has a female socket on one end and a male-ended cord on the other end, and is internally wired such that plugging the male-ended cord of one battery pack into the female socket of a second battery pack results in ganging the packs together in parallel.

### FIELD OF THE INVENTION

The present invention relates generally to dc battery holders.

### BACKGROUND OF THE INVENTION

Small, primary direct current (dc) batteries are used in a wide variety of applications owing to their low cost, ease of use, and portability. One such application is motorized window coverings. Window coverings such as horizontal blinds, vertical blinds, pleated shades, roll-up shades, and cellular shades made by, e.g., Spring Industries®, Hunter-Douglas®, and Levellor® can be motorized.

Indeed, the present assignee has provided several systems for either lowering or raising a window covering, or for moving the slats of a window covering between open and closed positions. Such systems are disclosed in U.S. Pat. Nos. 6,433,498, 6,338,377, 6,189,592, 6,060,852, 5,495,153, and 5,907,227, incorporated herein by reference. These systems include a motor driven gear box that is coupled to a tilt rod of the window covering. When the motor is energized, the tilt rod rotates clockwise or counterclockwise.

The assignee's systems are powered by multiple small (e.g., type AA) batteries that are mounted in the head rail of the window covering. The batteries can be conveniently mounted in a modular case or holder, for ease of installation and replacement. As recognized herein, however, many head rails are narrow, and thus require slim line battery packs. As further recognized herein, some window coverings might require a few batteries for operation while other window coverings might require a greater number of batteries. The present invention understands that it would be advantageous to provide battery packs that can be “ganged” together in parallel to render a more powerful and/or longer lasting battery pack assembly when required for larger window coverings without necessarily increasing the voltage provided by a single battery pack. Specifically, when Lithium batteries with long shelf lives are arranged as disclosed herein and used with any of the electrical control systems in the above-incorporated patents, long battery life can be obtained.

### SUMMARY OF THE INVENTION

A battery pack includes a hollow housing that defines a battery enclosure configured for holding at least one battery. A positive terminal and a negative terminal are supported on the housing, with a first connector being electrically connected to both terminals and with a second connector being electrically connected to both terminals.

In a preferred embodiment, the first connector is disposed at a first end of the housing and the second connector is disposed at a second end of the housing. The housing can includes opposed female sockets each defining first and second receptacles for engaging male plugs defining first and second elements. The first and second elements of the male plugs are respectively complementarily formed with the first and second receptacles of the female sockets.

In a non-limiting application, the battery pack can be held in the head rail of a window covering. A clip can be mounted on the head rail for detachably engaging the battery pack.

In one embodiment, the enclosure of the battery pack is configured for holding at least two batteries end-to-end. In another embodiment, the enclosure is configured for holding at least two columns of batteries, each column including at least two batteries oriented end-to-end with each other. The batteries can be type AA batteries or other type of batteries, such as camera batteries.

In another aspect, a battery carriage includes a housing configured for holding at least one battery, and positive and negative terminals electrically connected to positive and negative poles of a battery when the battery is disposed in the housing. First and second connector means are on the housing, with each connector means being electrically connected to both terminals.

In still another aspect, a method for powering a component includes providing at least a first battery pack that holds at least two batteries end-to-end and that has first and second connectors. The first connector includes a male connector and the second connector includes a female socket. The method also includes providing at least a second battery pack that is substantially identical to the first battery pack such that the first connector of the first battery pack is substantially identical to the first connector of the second battery pack and the second connector of the first battery pack is substantially identical to the second connector of the second battery pack. The battery packs are ganged together by engaging the first connector of the first battery pack with the second connector of the second battery pack.

The details of the present invention, both as to its construction and operation, can best be understood in reference to the accompanying drawing, in which like numerals refer to like parts, and which:

### BRIEF DESCRIPTION OF THE DRAWINGS

FIG. 1 is a perspective view of a modular battery pack, shown in one intended environment, with portions of the head rail cut away to expose the internal electrical components;

FIG. 2 is an exploded perspective view of two identical battery packs of a first embodiment, with portions of one battery pack broken away to show the single column of batteries oriented end-to-end and portions of one connector element shown in phantom; and

FIG. 3 is an exploded perspective view of a second embodiment of the battery pack, showing two columns of batteries disposed end-to-end.

### DETAILED DESCRIPTION OF THE PREFERRED EMBODIMENT

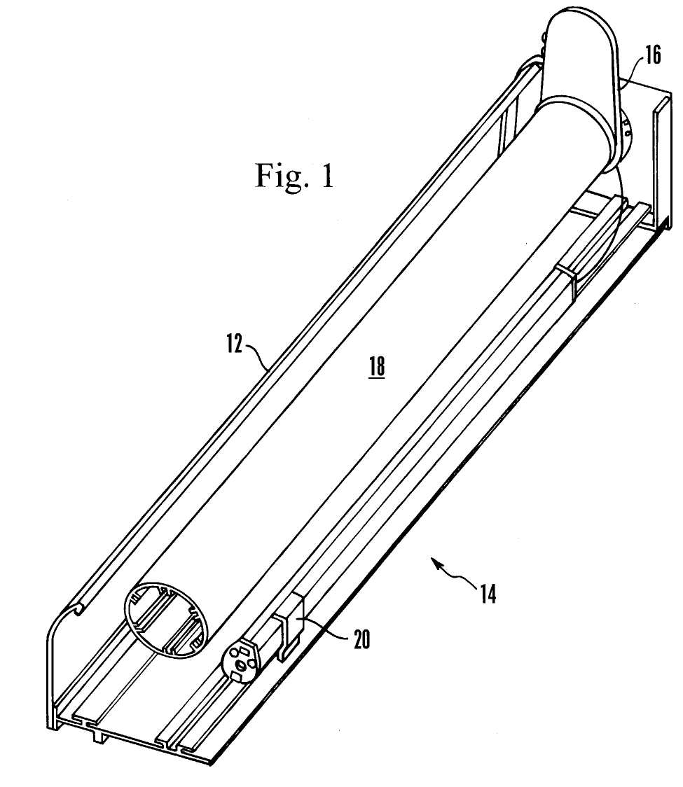

The present invention is directed to modular dc battery packs, also referred to as carriages, that can be used in a wide range of applications. By way of non-limiting illustration only, referring to FIG. 1, a modular battery power pack 10 is disposed in a head rail 12 of a window covering 14. The battery pack 10 is electrically connected to a dc motor assembly 16 that can include appropriate gearing and control circuitry including a microprocessor programmed according to any one of the above-referenced patents. The assembly 16 is mechanically coupled to a rotatable tilt rod 18, which in turn is coupled to slats or other movable features of the window covering 14 in accordance with principles known in the art to alter the amount of light passing through the window covering 14. FIG. 1 shows that the battery pack 10 is held by at least one plastic clip 20 that is affixed (as by, e.g., glue or fasteners) to the head rail 14. In a non-limiting embodiment, the battery pack 10 snaps into the clip 20 so that the battery pack 10 can be easily engaged and disengaged by hand with the head rail 14.

It is to be understood that the principles of the present invention apply to a wide range of window coverings. For example, the window covering 14 can be any window covering including, but not limited to the following: horizontal blinds, vertical blinds, fold-up pleated shades, roll-up shades, cellular shades, skylight covers, and any type of blinds that use vertical or horizontal louvered slats, including any of the motorized window coverings of the above-referenced patents that can be locally controlled and wirelessly controlled by a remote control device. It is to be further understood that the present battery pack can be used to power other non-limiting devices such as: laptop computers, hand held computers, telephones, lights, toys, calculators, or any other devices that can be powered by dc power sources.

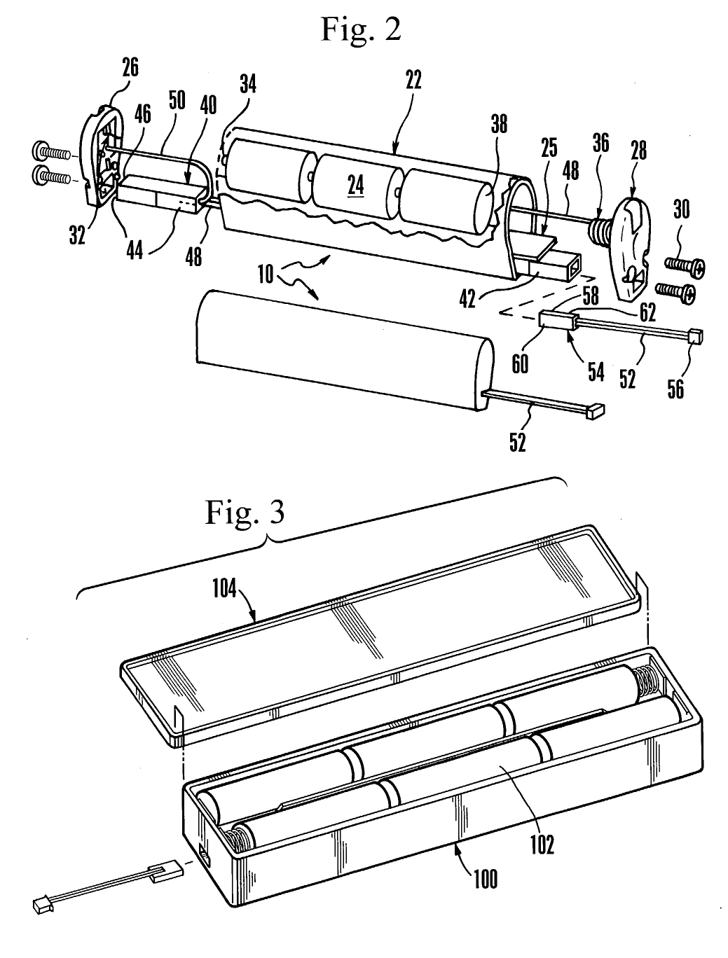

Now referring to FIG. 2, two identical battery packs 10, 10′ are shown that can be ganged together in electrical parallel to render a two-pack assembly that produces more power than a single pack but at the same voltage of the single pack. More than two battery packs can be ganged together if desired in accordance with present principles.

Focussing on the battery pack 10, a hollow, preferably plastic, generally cylindrical housing 22 can be produced by extrusion or other fabrication techniques and cut or molded to a length that is appropriate for holding a desired number of batteries 24. In the embodiment shown three type AA alkaline or Lithium batteries are disposed in the housing 22 end-to-end such that their voltages are cumulative. Other battery types can be used, e.g., camera batteries can be used. If desired, the batteries 24 can rest on a flat platform 25 that extends the length of the housing 22.

The housing 22 can include first and second end caps 26, 28, one or both of which can be detachably engaged with the body of the housing by threaded fasteners 30 or other fastening structure. When the end caps 26, 28 are attached to the body of the housing, the housing 22 forms a completely enclosed space in which the batteries 24 are disposed.

In the non-limiting embodiment shown in FIG. 2, the first end cap 26 bears a metal, generally flat positive terminal 32 that contacts a positive pole 34 of the nearest battery 24 when the end cap 26 is engaged with the body of the housing. Also, the second end cap 28 bears a metal spring-like negative terminal 36 that contacts a negative pole 38 of the nearest battery 24 when the end cap 28 is engaged with the body of the housing.

FIG. 2 further shows that the battery pack 10 can include two preferably identically-formed connector elements 40, 42 that are disposed opposite each other relative to the body of the housing 22. Each preferred non-limiting connector element 40, 42 establishes a female socket that includes two receptacles. Taking the connector element 40 as an example, first and second receptacles 44, 46 are established with the first receptacle 44 being electrically connected to the negative terminal 36 via a conductor 48 and with the second receptacle 46 being electrically connected to the positive terminal 32 via a conductor 50. It is to be understood that the connector element 42 likewise is a female socket that has first and second receptacles respectively connected to the negative and positive terminals 36, 32.

In accordance with the preferred non-limiting embodiment shown in FIG. 2, one of the connector elements (in the case shown, the connector element 42) is engaged with a two-lead cord 52 that has opposed male plugs 54, 56 at least one of which is complementarily configured to the connector element 42. It is to be understood that, e.g., the left-most male plug 54 includes first and second male elements 58, 60 that respectively engage the first and second receptacles of the connector element 42. Also, the right-most male plug 56 includes first and second male elements that are electrically connected through the cord 52 with the corresponding male elements of the left-most plug 54. A key 62 or other alignment structure can be formed on each plug 54, 56 to slidably engage complementary structure in a connector element only when the plug is properly inserted into the connector element, i.e., with the first male element of the plug oriented to electrically contact the first receptacle of the connector element and with the second male element of the plug oriented to electrically contact the second receptacle of the connector element. Together, the second connector element 42 and two-lead cord 52 with plugs 54, 56 establish a male plug connector, whereas the first connector element 40 establishes a female socket connector.

While FIG. 2 shows plugs 54, 56 and connector elements 40, 42 that are parallelepiped-shaped plastic electrical connectors, with the male elements essentially being established by respective contacts within the plugs 54, 56, other types of connections can be used. For example, the connector elements 40, 42 can be simple sockets and the plugs 54, 56 can be conventional male plugs that have externally-protruding prongs.

In any case, it may now be appreciated that the cord 52 may be engaged with the motor assembly 16 (FIG. 1) to power the window covering 14 through any one of the electrical circuits disclosed in the above-incorporated patents. Or, the right-most plug 56 of the cord 52 can be engaged with the free connector element (i.e., the female connector) of the battery pack 10′ to gang the two battery packs 10, 10′ together, with the cord 52′ of the battery pack 10′ then being used to connect the battery packs 10, 10′ to a load or to yet another battery pack (not shown).

It is to be further appreciated that owing to the internal wiring described above, when the battery packs 10, 10′ are ganged together, the negative terminals of the packs 10, 10′ are connected together and the positive terminals are likewise connected together, resulting in a parallel connection. In other words, the batteries in the pack 10, while being in electrical series with each other, are in electrical parallel with the batteries in the other pack 10′. Series connection of the packs 10, 10′ can also be achieved if desired simply by reversing the terminal connections of the receptacles of either connector element.

FIG. 3 show an alternate battery pack 100 that is in all substantial respects identical to the pack 10 shown in FIGS. 1 and 2, except that it is generally flat and parallelepiped-shaped and it holds two columns of series-oriented batteries 102. A removable lid 104 can be provided.

While the particular MODULAR BATTERY PACK as herein shown and described in detail is fully capable of attaining the above-described aspects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. section 112, sixth paragraph, unless the element is expressly recited using the phrase “means for.”

WE CLAIM:

What is claimed is:

1. A battery pack, comprising:
a hollow housing defining a battery enclosure configured for holding at least one battery;
at least one positive terminal and at least one negative terminal supported on the housing;
a first connector electrically connected to both terminals; and
a second connector electrically connected to both terminals.

2. The battery pack of claim 1, wherein the first connector is disposed at a first end of the housing and the second connector is disposed at a second end of the housing, the first and second ends being opposite each other.

3. The battery pack of claim 1, wherein the first connector includes a female socket defining first and second receptacles and the second connector includes a male plug defining first and second elements, the first and second elements being respectively complementarily formed with the first and second receptacles.

4. The battery pack of claim 3, wherein the battery pack is a first battery pack, and the first receptacle and first element are electrically connected to the negative terminal and the second receptacle and second element are electrically connected to the positive terminal such that when the second connector is engaged with a first connector of a second battery pack identical in configuration to the first battery pack, the battery packs are electrically in parallel with each other.

5. The battery pack of claim 3, wherein the battery pack is a first battery pack, and the first receptacle and second element are electrically connected to the negative terminal and the second receptacle and first element are electrically connected to the positive terminal such that when the second connector is engaged with a first connector of a second battery pack identical in configuration to the first battery pack, the battery packs are electrically in series with each other.

6. The battery pack of claim 1, further comprising a head rail of a window covering for holding the battery pack.

7. The battery pack of claim 6, further comprising at least one clip mounted on the head rail for detachably engaging the battery pack.

8. The battery pack of claim 1, wherein the enclosure is configured for holding at least two Lithium batteries end-to-end.

9. The battery pack of claim 1, wherein the enclosure is configured for holding at least two columns of batteries, each column including at least two batteries oriented end-to-end with each other.

10. The battery pack of claim 1, wherein the housing includes at least one end cap detachably engaged with an elongated body.

11. The battery pack of claim 1, comprising at least one Lithium battery disposed in the battery enclosure.

12. A battery carriage, comprising:
a housing configured for holding at least one battery;
positive and negative terminals electrically connected to positive and negative poles of a battery when the battery is disposed in the housing; and
first and second connector means on the housing, each connector means being electrically connected to both terminals.

13. The carriage of claim 12, wherein the connector means are identical to each other.

14. The carriage of claim 13, wherein the connector means are formed opposite each other on the housing.

15. The carriage of claim 13, further comprising a cord having opposed plugs, at least one of the plugs being configured for engaging at least the first connector means.

16. The carriage of claim 12, further comprising a head rail of a window covering for holding the battery pack.

17. The carriage of claim 15, wherein the cord and first connector means establish a first connector defining a male plug in turn defining first and second elements and the second connector means establishes a second connector defining first and second receptacles, the first and second elements being respectively complementarily formed with the first and second receptacles.

18. The carriage of claim 17, wherein the carriage is a first carriage, and the first receptacle and first element are electrically connected to the negative terminal and the second receptacle and second element are electrically connected to the positive terminal such that when the second connector is engaged with a first connector of a second carriage identical in configuration to the first carriage, the carriages are electrically in parallel with each other.

19. A method for powering a component, comprising:
providing at least a first battery pack holding at least two batteries end-to-end and having at least first and second connectors, the first connector including a male connector and the second connector including a female socket;
providing at least a second battery pack holding at least two batteries end-to-end and having at least first and second connectors, the second battery pack being substantially identical to the first battery pack such that the first connector of the first battery pack is substantially identical to the first connector of the second battery pack and the second connector of the first battery pack is substantially identical to the second connector of the second battery pack; and
ganging the battery packs together by engaging the first connector of the first battery pack with the second connector of the second battery pack.

20. The method of claim 19, comprising wiring the connectors such that when ganged together, the batteries in the first battery pack are electrically in parallel with the batteries in the second battery pack.

21. The method of claim 19, comprising wiring the connectors such that when ganged together, the batteries in the first battery pack are electrically in series with the batteries in the second battery pack.
